(19) United States
(12) Patent Application Publication
(10) Pub. No.: US 2009/0050617 A1
(43) Pub. Date: Feb. 26, 2009

(54) Method and device for melting snow and ice

(76) Inventors: Natan Neta Paris, Lod (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/894,094

(22) Filed: Aug. 21, 2007

(51) Int. Cl. H05B 1/00; H05B 1/02; H05B 3/02

(52) U.S. Cl. 219/213; 219/492; 219/540

(57) ABSTRACT

Modular mats connected physically and electrically with heating wires in the mats to melt snow and/or ice that would otherwise settle or form on the mats. Mats may be added or subtracted to increase or decrease the size of the total carpet of mats while maintaining an electrical circuit in the mats connected to a power supply. Transformer to reduce voltage. Weight sensor to activate or de-activate the electrical power supply.

### FIELD OF THE INVENTION

This invention is in the field of sidewalk safety in times of subzero weather conditions and in particular using mats to lie on the ground to melt any snow that falls on them or ice that forms on them.

### BACKGROUND OF THE INVENTION

The absence of frictional resistance when a body comes in contact with snow or ice is well known. It is this phenomenon that makes skiing and ice skating such enjoyable sports. On the other hand, it is the same phenomenon that can cause much pain and suffering to those unfortunate individuals who slip and fall in subzero weather. The injuries thereby caused range from light bruises to, for example, serious fractures of the hips.

This invention could be used by individuals in their private property and equally by local authorities on a larger scale to make for example, sidewalks or steps safe during the winter.

Another use could be on steps or sloping paths as they are particularly hazardous when snow falls or ice forms.

A common solution to this problem is to sprinkle salt over the area and the resulting salt solution will usually stay liquid. This is because a saline solution freezes at a lower temperature than pure water. Most solutions will have this effect. Salt is used as it is relatively inexpensive and readily available. The greater the concentration the saline solution, the lower the freezing point of the resultant liquid.

There are a number of disadvantages of sprinkling salt, namely, that it requires much labor to constantly renew the supply of salt. When a sprinkling of salt has melted, the salt solution usually runs away and the salt needs to be replaced to prevent ice reforming.

Another disadvantage is that the salt solution can cause damage to plant life and also can cause corrosion to metal when metal and the solution are in contact for prolonged periods.

A third disadvantage is that in very cold climates the usual amount of salt used for melting will not make a solution sufficiently concentrated to melt the snow and ice and large additional quantities of salt will need to be used. This will accentuate the problems above mentioned of damage to plant life and metal corrosion the cost of the salt and the time and manpower to spread the salt over large areas repeatedly.

This invention comes to provide a solution for those who wish to make a safe surface for walking where snow falls and ice forms, for example, on steps, paths, sidewalks and larger areas.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute a part of this specification. The drawings illustrate various embodiments of the invention and, together with the description serve to explain the principles and operations of the invention.

This invention uses module mats wired for use with low voltage electricity and offering an electrical resistance to create a slight warming effect when electricity flows through the wires. The mats can be any convenient size and could be attachable and detachable one to the other with ease thereby enabling flexibility to fit a wide variety of surfaces required to be covered. For example, a long narrow mat could be used on steps. The mats are attachable one to the other for the purpose of making a unified and complete surface for walking upon and for the purpose of making the electrical connection from one mat to the other.

A transformer could be used to reduce the voltage from the mains alternate current to for example, twelve volt direct current. This would be necessary to eliminate the danger of electrification resulting from direct contact between the electric wires, the melting snow or ice, and the person walking on the said mats. The transformer would preferably be adjustable to accommodate the need to use different currents of electricity to be effective to operate with varyious quantities of mats.

An object of this invention is to have mats on the ground so that people can walk in a steady and sure footed manner on the mats even in icy weather conditions.

Another object of this invention is to heat the said mats or part of them with a safe form of electricity.

Another object of this invention is for the heated mats to be attachable and detachable without using special instruments. This connection is for the purpose of holding the mats physically together to form one unified surface for safe walking. Another purpose of this connection is to make an electrical connection between the mats.

Another object of this invention is for the mats to be in modular form so that they can fit many different sized surfaces.

Another object of this invention is that mats may be added to existing mats and maintain a complete electrical circuit.

Similarly, mats may be removed from the circuit and the electrical circuit remains complete.

Another object of this invention is for the mats to be fitted vertically against the vertical part of a step or against a wall to prevent snow and ice forming on such surfaces. There would be a possibility of a ninety degree angle physical and electrical connection with mats on a horizontal surface. This invention would have a particularly useful application on steps as they are particularly hazardous when covered in ice or snow and a fall on stairs often has more serious consequences than a fall on flat ground.

Another object of this invention is to have an option to switch on the heating elements or a portion of the only when someone steps on the mats. This could be a weight sensitive sensor or an electronic eye. This could be used to save electricity when the mats are not used for an extended amount of time. Alternatively the electricity could be made to switch on when the weight of the snow and ice reaches a certain weight. This would save electricity when the snow is intermittent. A narrow strip of mats could have their heating elements working all the time to ensure there is an ice free path. The rest of the mats could have their heating elements switched on when people begin to tread on the mats. A time switch could be used to turn on the electricity at a certain time each day shortly before the time it is known that people start using the mats. The option used would depend on the situation in the field and the needs of the people affected.

Another object of this invention is to have electrical wires and connections hardy enough to withstand heavy weights on them.

Another object of this invention is to have a smooth and non-slip walkable surface for use in subzero temperatures, free from snow and ice.

Another object of this invention is to have lights embedded in the said mats to demark the edge of the mat and/or for aesthetic purposes.

### BRIEF DESCRIPTION OF THE DRAWINGS

The accompanying drawings, which are incorporated in and form a part of this specification, illustrate embodiments of the invention and, together with the description, serve to explain, by way of example only, the principles of the invention:

FIG. 1 is a schematic depiction of an example of a mat of this invention.

FIG. 2 is a schematic depiction of the cross section of the said mat.

FIG. 3 is a schematic depiction of a number of mats joined together, on a path from a house to the sidewalk adjoining the house.

FIG. 4 is a schematic depiction of the mat of this invention on steps.

FIG. 5 is an electrical diagram showing one option for electrical circuits in the mats.

### DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

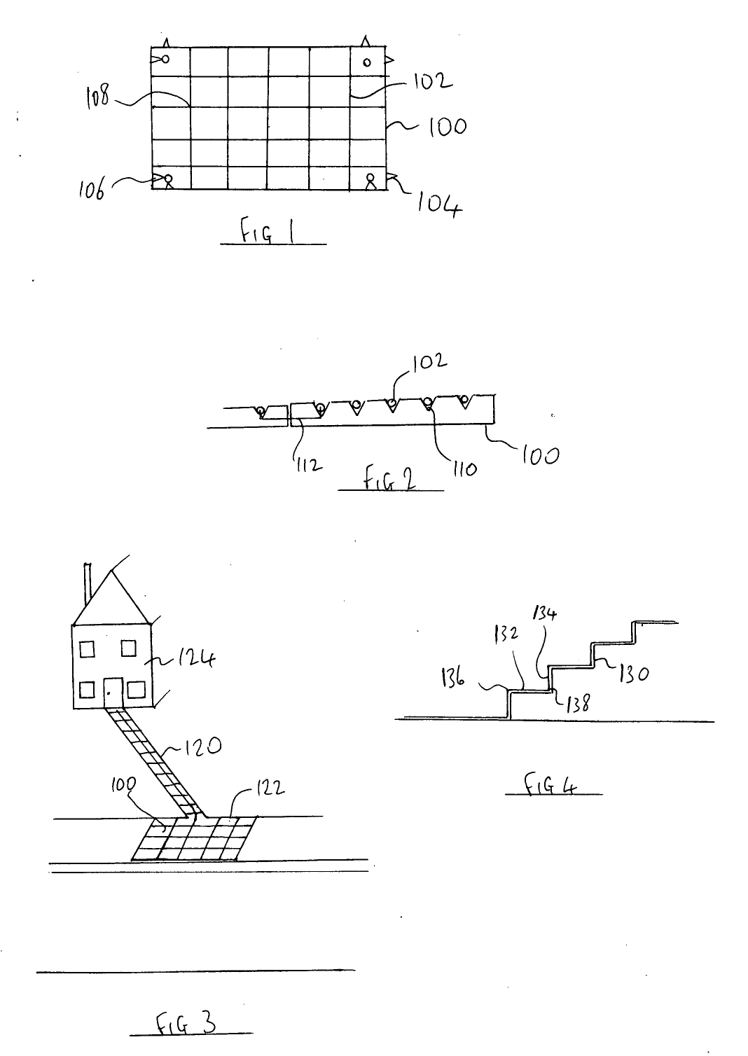

FIG. 1 shows an example of a mat 100 incorporating heating elements 102 and clip devices comprising a male component 104 and a female component 106 whereby mats can be attached and detached. The said clips could also contain the electrical circuit connections to ensure the electrical circuit remains complete. When the heating elements 102 cross each others path 108 the wire of the heating elements would be reinforced with extra insulating material to prevent an electrical short circuit.

FIG. 2 shows a mat 100 from the side or sectional view. The mat 100 has groves 110 in which are the electrical heating elements 102. The mats 100 are joined electrically with connectors 112 that are pushed together to make a connection between the mats and pulled apart to break the connection when separating the mats 100.

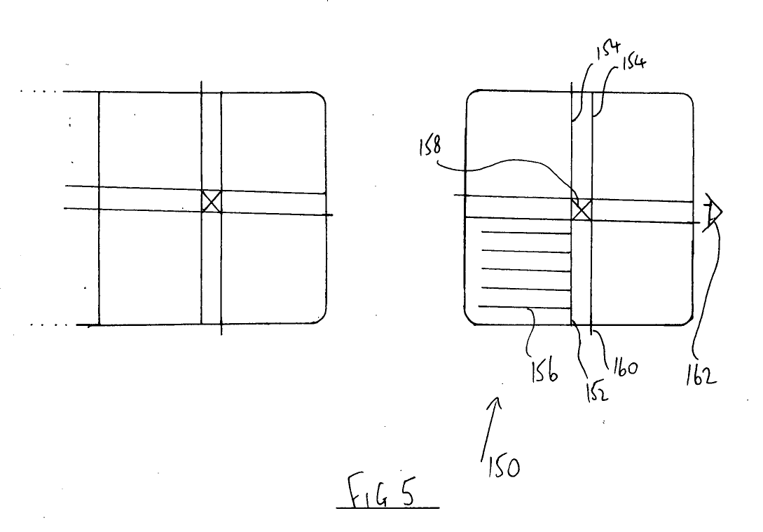

FIG. 3 shows an application of this invention, namely on a path 120 leading from a house 124 to an area 122 on the sidewalk close to the path 120.

The source of electricity could be from the mains electricity of the house 124 using a transformer to lower the voltage to a harmless level. The mats 100 are various sizes and fit into each other to make a physical and electrical connection.

FIG. 4 shows stairs 130 with mats lying horizontally 132 and vertically 134 connected physically and electrically at the points of meeting 136 and 138.

FIG. 5 shows a set of mats 150 each with a set of electrical connectors 152 facing out from all four sides of the mat 150. The wires 154 are the heating elements that melt the 15 snow and ice when electricity is passed through them. There could be vanes 156 from the heating elements 154 to other parts of the mat 150 to help dissipate the heat to parts of the mat far from the heating elements 154.

A weight sensitive device 158 could be used to switch on the 20 electricity when a certain weight of snow or ice has accumulated and switch off the electricity a set time after the weight falls to zero grams. Alternatively, a time clock could operate the electricity before the times people are expected to use the mats and switch the electricity off at times when people are unlikely to be present.

There would be connecting pins 160 to enable the mats to be electrically connected. The electrical circuit would be completed with the end piece 162.

What is claimed:

1. A method and device for melting snow and ice comprising,
a. mats connected with connections to physically hold the said mats adjacent one next to the other,
b. the said mats connected with male-female electrical connections,
c. heating elements in the said mats,
d. a source of electricity connected to the said mats, and
e. an electrical connector to complete the electrical circuit in the said mats,
whereby the electricity heats the said heating elements and melts ice and snow on the said mats.

2. A method and device for melting snow and ice as claimed in claim 1 further comprising a weight sensor that would connect the said electric circuit when a given weight of snow or ice settles on the said sensor.

3. A method and device for melting snow and ice as claimed in claim 2 wherein the said sensor is integrated into the said mats.

4. A method and device for melting snow and ice as claimed in claim 1 further comprising a timer device to pre-set the times when the said electricity could operate the said heating elements in the said mats.

5. A method and device for melting snow and ice as claimed in claim 1 wherein at least a portion of the said mats are at an angle smaller than 180° relative to adjacent connected mats.

6. A method and device for melting snow and ice as claimed in claim 1 further comprising vanes in the said mats to dissipate heat from the said heating elements to other portions of the said mats.

7. A method and device for melting snow and ice as claimed in claim 1 wherein the said physical and said electrical connections are capable of disconnection and reconnection.

8. A method and device for melting snow and ice as claimed in claim 1 wherein the said source of electricity is mains electricity with a transformer to reduce the voltage.

9. A method and device for melting snow and ice as claimed in claim 1 wherein the said source of electricity is a battery.

10. A method and device for melting snow and ice comprising,
a. mats connected with connections to physically hold the said mats adjacent one next to the other,
b. the said mats connected with male-female electrical connections,
c. heating elements in the said mats,
d. a source of electricity connected to the said mats,
e. an electrical connector to complete the electrical circuit in the said mats,
f. a weight sensor that would connect the said electric circuit when a given weight of snow or ice settles on the said sensor,
g. a weight sensor that would disconnect the said electric circuit when a given weight of snow or ice melts off the said sensor,
h. a timer device to pre-set the times when the said electricity could operate the said heating elements in the said mats, and
i. vanes in the said mats to dissipate heat from the said heating elements to other portions of the said mats,
whereby the electricity heats the said heating elements and melts ice and snow on the said mats.

11. A method and device for melting snow and ice as claimed in claim 10 wherein at least a portion of the said mats are at an angle smaller than 180° relative to adjacent connected mats.

12. A method and device for melting snow and ice as claimed in claim 10 wherein the said physical and said electrical connections are capable of disconnection and reconnection.

13. A method and device for melting snow and ice as claimed in claim 10 wherein the said source of electricity is mains electricity with a transformer to reduce the voltage.

14. A method and device for melting snow and ice as claimed in claim 10 wherein the said source of electricity is a battery.
